(19) United States
(12) Patent Application Publication
(10) Pub. No.: US 2011/0246829 A1
(43) Pub. Date: Oct. 6, 2011

(54) Method for Fast Detection of Node Mergers and Simplification of a Circuit

(75) Inventors: Yung-Chih CHEN, Hsin Chu City (TW); Chun-Yao WANG, Hsin Chu City (TW)

(73) Assignee: National Tsing Hua University, Hsin Chu City (TW)

(21) Appl. No.: 12/830,457

(22) Filed: Jul. 6, 2010

(30) Foreign Application Priority Data
Apr. 1, 2010 (TW) 099110161

(51) Int. Cl. G06F 11/263

(52) U.S. Cl. 714/32; 714/E11.177

(57) ABSTRACT

The present invention discloses a method for fast detection of node mergers and simplification of a circuit. The steps of the method include: (a) a circuit with a large amount of nodes is provided; (b) a target node is selected for computing mandatory assignments (MAs) of the stuck-at 0 and stuck-at 1 fault tests on the target node respectively by a computer; (c) the MAs of the stuck-at 0 and stuck-at 1 fault tests of the target node are utilized to find substitute nodes; (d) the substitute node that is closest to primary inputs is used to replace the target node; and (e) the steps (b)˜(d) are repeated for removing the replaceable nodes and simplifying the circuit.

### CROSS-REFERENCE TO RELATED APPLICATION

This present application claims priority to TAIWAN Patent Application Serial Number 099110161, filed Apr. 1, 2010, which is herein incorporated by reference.

### TECHNICAL FIELD

The present invention relates to a method for detection of node mergers in a circuit, and more particularly to a method of fast detection of node mergers for node merging by using logic implications.

### RELATED ART

With rapid development of semiconductor process technology, the designs of very-large scale integrated (VLSI) circuits become more complex. For a more complicated design of a VLSI circuit, the internal feature of the VLSI circuit will produce redundancy, which means the same data are stored repeatedly causing waste of space of the VLSI circuit.

Thus, in order to reduce the redundancy for simplifying the VLSI circuits, typically, it uses a method of merging nodes. Merging nodes comprise a way of using a node to replace another node in a circuit without changing the overall functionality of the circuit, so that the redundancies are removed effectively for reducing the size of the VLSI circuit.

Boolean satisfiability (SAT) sweeping method is proposed to merge two functionally equivalent nodes to achieve aforementioned purpose. The steps of the method includes: first, a circuit is simulated by applying a set of random patterns; next, the node merger candidates are derived by searching two nodes that have the same simulation values; finally, a SAT solver is used to check if these nodes are actually equivalent. (Please refer to A. Kuehlmann, “Dynamic Transition Relation Simplification for Bounded Property Checking,” in Proc. Int. Conf. on Computer-Aided Design, 2004, pp. 50-57.) The mentioned-above method merges the nodes possessing functional equivalence for simplifying the VLSI circuit. However, SAT solving operation could be very complicated and spend much time. The SAT-based method needs to repeatedly execute the SAT solver so that this method is actually time-consuming, especially, when it is utilized to simplify a large circuit. Additionally, the functional equivalence is not a necessary condition for node merging. In fact, if the functional differences of two nodes are not observed at any primary output (PO), these two nodes can be merged as well. This refers to so-called ODCs (Observailibity Don't Care). Based on this concept, the local ODC-based algorithm extends the SAT sweeping method to merge two nodes that are not functionally equivalent to each other for further simplifying a VLSI circuit. (Please refer to Q. Zhu, N. Kitchen, A. Sangiovanni-Vincentelli, “SAT Sweeping with Local Observability Don't Cares,” in Proc. Design Automation conf., 2006, pp. 229-234.)

FIGS. 1A-B illustrate the node mergers under local ODCs. In the prior art, an And-Inverter Graph (AIG) is used to present a circuit for simplicity. In this circuit, it has four primary inputs (PIs), shown as a, b, c, and d, respectively. Moreover, nodes u₁˜u₅ are all 2-input AND gates. In this illustration, a dot marked on an edge indicates that an inverter (INV) is in between two nodes.

At first, referring to FIG. 1A, in the circuit 1, the nodes u₁ and u₃ are not functionally equivalent, and thus, merging them potentially affects the overall functionality of the circuit 1. However, the values of nodes u₁ and u₃ only differ when d=1 and b=c. The expression of b=c implies node u₂=0. Since u₂=0 is an input-controlling value of node u₅, it prevents a different value of node u₃ from being observed at node u₅. Thus, this situation makes the different values of node u₃ with respect to node u₁ never observed at PO. Therefore, replacing node u₃ with node u₁ does not change the overall functionality of the circuit 1. Referring to FIG. 1B, the circuit 1′ is a simplified version of the circuit 1 after the node u₃ is replaced with the node u₁. In this circuit 1′, it shows the PO is not affected by replacing the node u₃ with the node u₁. Thus, the nodes u₁ and u₃ can be merged for simplifying the circuit.

Although this method can detect more node mergers than SAT sweeping method, it sets a k-bounded depth to extract local ODCs because full observability computation is very time-consuming. Thus, with larger values of k, the method can identify more node mergers but spends much calculating time.

On the other hand, another work proposes a node-merging algorithm under global ODCs by using the SAT sweeping technique as well in recent years for enhancing the detection of node mergers and simplifying the VLSI circuit. (Please refer to S. Plaza, K. H. Chang, I. Markov, and V. Bertacco, “Node Mergers in the presence of Don't cares,” in Proc. Asia South Pacific Design Automation Conf, 2007, pp. 414-419.) This method is not limited to a k-bounded depth, and can detect certain node mergers that cannot be identified by the local ODC-based method. However, this method potentially misses some other node mergers as well due to approximate ODCs calculation.

Although the SAT-based techniques with local ODCs and global ODCs as mentioned above for detecting node mergers and simplifying the VLSI circuit decrease the complexity of observability computation, they cannot avoid performing ODC analysis in searching for a node merger. Additionally, they need to simulate a large amount of random patterns, collect candidate node mergers, and then perform SAT solving. This procedure can be very time-consuming due to a potentially large number of SAT solving calls when the number of candidates is enormous. Thus, what is required is a method for fast detection of node mergers and simplification of VLSI circuits.

### SUMMARY

One objective of the present invention is to merge nodes effectively for simplifying a VLSI circuit.

Another objective of the present invention is to enhance the mentioned-above traditional detection method of node mergers by saving the CPU time.

In order to achieve the foregoing objectives, the present invention provides a method for fast detection of substitute nodes, and the steps of the method include: (a) a circuit with a large amount of node is provided; (b) a target node is selected for computing mandatory assignments (MAs) of the stuck-at 0 and stuck-at 1 fault tests on the target node respectively by a computer; and (c) the MAs of the stuck-at 0 and stuck-at 1 fault tests of the target node are utilized to find the substitute nodes.

Moreover, the present invention also provides a method for fast detection of node mergers and simplification of a circuit, and the steps of the method include: (a) a circuit with a large amount of nodes is provided; (b) a target node is selected for computing MAs of the stuck-at 0 and stuck-at 1 fault tests on the target node respectively by a computer; (c) the MAs of the stuck-at 0 and stuck-at 1 fault tests of the target node are utilized to find the substitute nodes; (d) the substitute node that is closest to primary inputs is used to replace the target node; and (e) the steps (b)˜(d) are repeated for removing the replaceable nodes and simplifying the circuit.

Furthermore, the present invention still provides a method for fast detection of complemented substitute nodes, and the steps of the method include: (a) a circuit with a large amount of nodes is provided; (b) a target node is selected for computing MAs of stuck-at 0 and stuck-at 1 fault tests on the target node respectively by a computer; (c) the MAs of the stuck-at 0 and stuck-at 1 fault tests of the target node are utilized to find the substitute nodes that can replace the target node together with an additional inverter; wherein the inverter is utilized to transfer a logical value “1” to “0” or “0” to “1”.

The advantage of the present invention is to provide a method for fast detection of node mergers using logic implications under the ODCs. The node mergers are detected by using logic implications and techniques of redundancy removal and MA reuse, for simplifying a VLSI circuit effectively and efficiently.

A detailed description is given in the following embodiments and with reference to the accompanying drawings and claims.

### BRIEF DESCRIPTION OF THE DRAWINGS

FIG. 1 shows an illustration of node mergers under local ODCs.

FIG. 2 shows the flow chart of the method for fast detection of node mergers and simplification of a circuit according to the present invention.

FIGS. 3A-B illustrate the effect of node merging.

FIG. 4 illustrates that the node u₅ is not a substitute node.

FIGS. 5A-B show the illustrations of the method for fast detection of node mergers and simplification of a circuit according to the present invention.

FIGS. 6A-B illustrate the rules of MA reuse.

### DETAILED DESCRIPTION

The invention hereinafter will be described in detail with preferred embodiments of the invention and accompanying illustrations. Nevertheless, it should be recognized that the preferred embodiments of the invention are not provided to limit the invention but to illustrate it. The present invention can be practiced not only in the preferred embodiments herein mentioned, but also in a wide range of other embodiments besides those explicitly described. Furthermore, the scope of the present invention is expressly not limited to any particular embodiments except what is specified in the appended Claims.

The present invention and embodiments now are described in detail. In the diagrams and descriptions below, the same symbols are utilized to represent the same or similar elements. The main features of the embodiments of the present invention are described in highly simplified illustration. Additionally, the drawings of the present invention do not indicate every characteristic of the actual embodiments, and all elements of the drawings are not depicted in proportional size but in relative size.

The present invention discloses a method for fast detection of node mergers by using logic implications under the concept of ODCs. In this invention, the node mergers are detected by using logic implications and two techniques, redundancy removal and MA reuse, are engaged for simplifying a VLSI circuit effectively and efficiently.

In order to describe the features of the present invention more clearly, it reviews some terminologies used in logic synthesis and related concepts used in a VLSI testing.

At first, an input of a gate g has an input-controlling value of g if this value determines the output value of g regardless of the other inputs. The inverse of the input-controlling value is called the input-noncontrolling value. For example, the input-controlling value of an AND gate is 0 and its input-noncontrolling value is 1.

Furthermore, a gate g is in the transitive fanout cone of a gate gₛ, if there exists a path from gₛ to g, and gₛ is in the transitive fanin cone of g.

Dominators of a gate g are a set of gates G such that all paths from g to any PO have to pass through all gates in G. Consider the dominators of a gate g: the side inputs of a dominator are its inputs that are not in the transitive fanout cone of g.

Additionally, in VLSI testing; a stuck-at fault is a fault model used to represent a manufacturing defect within a circuit. The effect of the fault is as if the faulty wire was stuck at either 1 or 0. A stuck-at fault test is a process to find a test which can generate the different output values in the fault-free and faulty circuits. Given a stuck-at fault f, if there exist such as a test, f is said to be testable; otherwise, f is untestable. Here, to make a stuck-at fault on a wire testable, a test needs to activate and propagate the fault effect to a PO. In a combinational circuit, an untestable stuck-at fault on a wire indicates that the wire is redundant and can be replaced with a constant value 0 or 1.

Mandatory assignments (MAs) are the unique value assignments to nodes necessary for a test to exist. Consider a stuck-at fault on a wire, the assignments obtained by setting this wire to the fault-activating value and by setting the side inputs of dominators of this wire to the fault-propagating values are MAs. Then, these assignments can be propagated forward or backward to infer additional MAs by performing logic implications. Recursive learning is a learning method in automatic test pattern generation (ATPG), and it can be used to perform logic implications more completely. If the MAs of the fault on a wire are inconsistent, the fault is untestable, and therefore, this wire is redundant and can be removed.

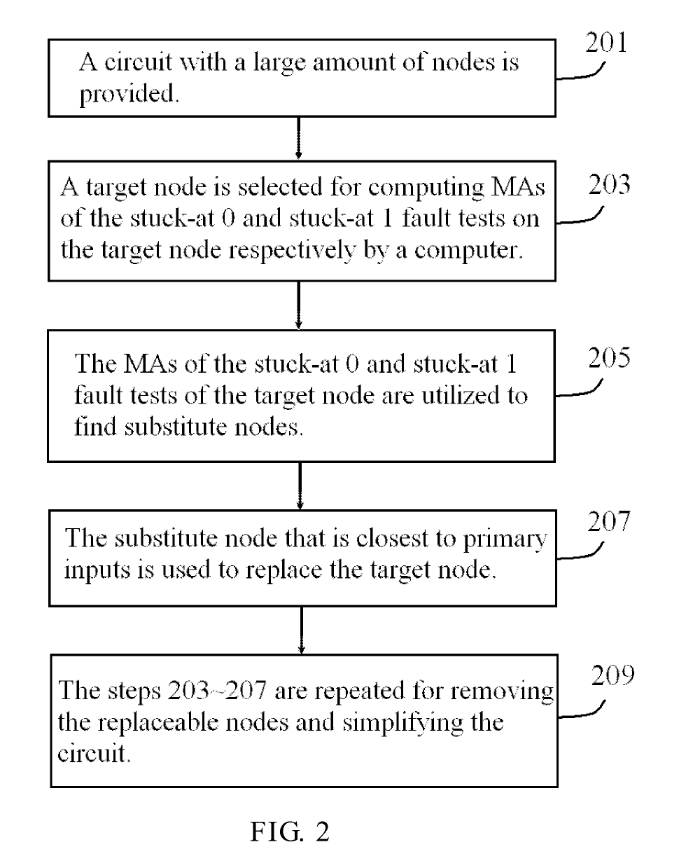

Referring to FIG. 2, it shows the flow chart of a method for fast detection of node mergers and simplification of a circuit according to the present invention. The steps of this method include: initially, the step 201 shows that a circuit with a large amount of nodes is provided; sequentially, the step 203 shows that a target node is selected for computing MAs of the stuck-at 0 and stuck-at 1 fault tests on the target node respectively by a computer; next, the step 205 shows that the MAs of the stuck-at 0 and stuck-at 1 fault tests of the target node are utilized to find substitute nodes; furthermore, the step 207 illustrates that the substitute node which is closest to primary inputs is used to replace the target node; and in step 209, it involves that the steps 203-207 are repeated for removing the replaceable nodes and simplifying the circuit. This method disclosed in the present invention can reduce the calculating processes of the prior art dramatically, and the redundancy in a circuit can be detected quickly, followed by removing the redundancy for simplifying the circuit. The calculating process is preferably calculated by a computer.

Now, the mentioned-above steps according to the present invention are described below in detail.

Initially, in step 201, a VLSI circuit is provided, and the circuit design includes a plurality of gates. In order to simplify a logic circuit, the present description uses the And-Inverter Graph (AIG) for presenting the circuit. In the aspect, a node is defined as a feature of a logic gate.

Sequentially, in step 203, a target node is selected for computing MAs of the stuck-at 0 and stuck-at 1 fault tests on the target node, respectively, by a computer; and in step 205, the MAs of the stuck-at 0 and stuck-at 1 fault tests of the target node are utilized to find substitute nodes.

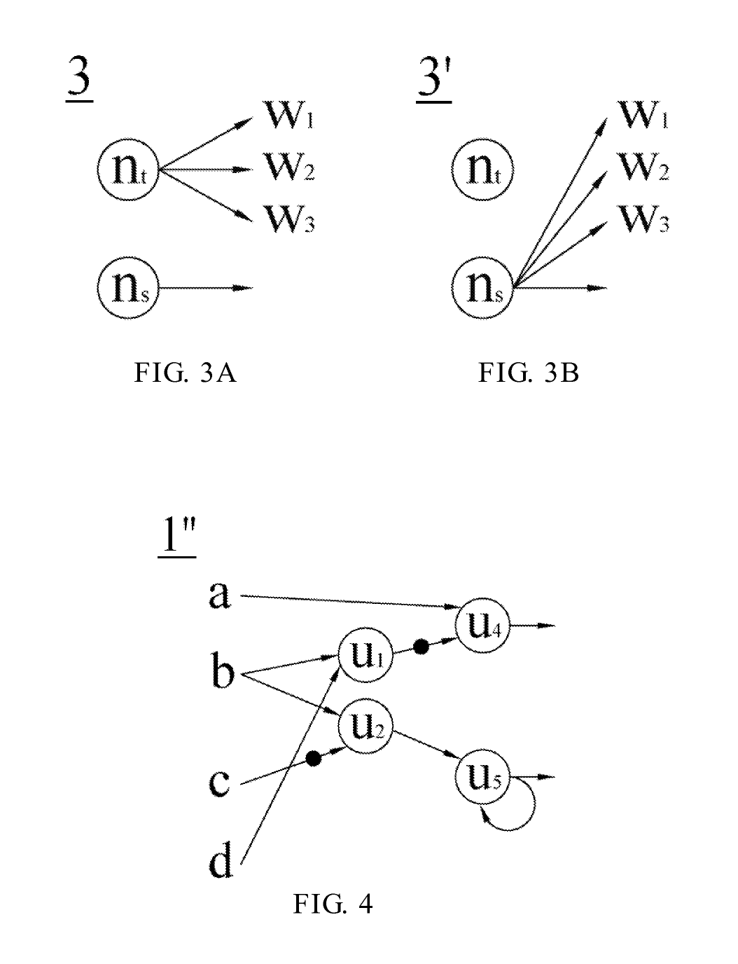

In order to describe the features in steps 203 and 205 more clearly, the effect of merging two nodes is introduced first. Referring to FIG. 3A, a circuit 3 is a combinational circuit, and node nₜ is a target node. Suppose a node nₛ in the circuit 3 is used to replace the target node nₜ to drive the wires w₁˜w₃ originally driven by the target node nₜ. Next, referring to FIG. 3B, the target node nₜ is replaced with node nₛ in the circuit 3′ and this replacement can be modeled as a misplaced wire error of the wires w₁˜w₃ which should be connected with nₜ instead of nₛ. (Please refer to M. S. Abadir, J. Ferguson, and T E. Kirkland, “Logic Design Verification via Test Generation,” IEEE Trans. Computer-Aided Design, vol. 7, pp. 138-148, January 1988.) However, for some nₜ and nₛ nodes, the replacement error is undetectable when the error effect is never observed at any PO. In this situation, the target node nₜ can be replaced with node nₛ without changing the circuit's functionality.

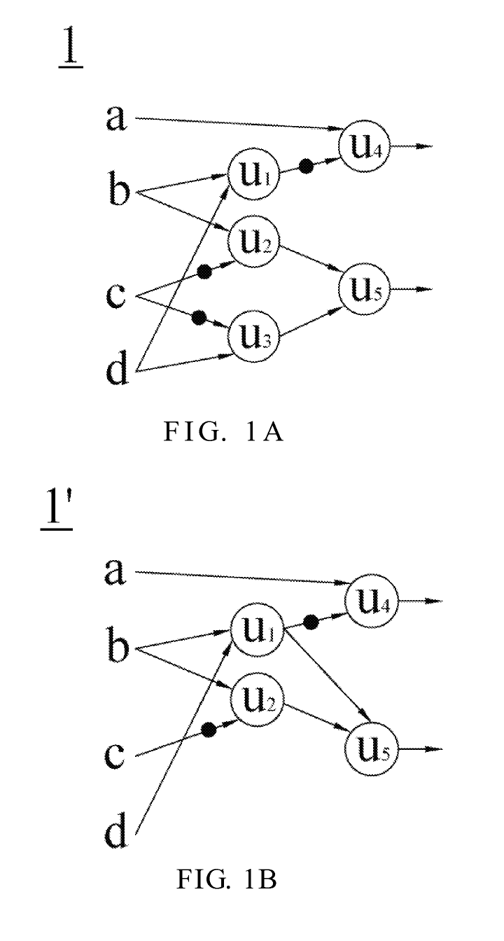

If nₛ=1 and nₛ=0 are MAs for the stuck-at 0 and stuck-at 1 fault tests on the target node nₜ respectively, the error of replacing nₜ with nₛ is undetectable. For example, referring to the circuit design shown in FIG. 1A, a target node u₃ is selected to be replaced. Consider the MAs of the stuck-at 0 fault test on u₃. To activate the fault effete, the node u₃ is set to 1, and to propagate the fault effect, the node u₂ is also set to 1. When logic implications are performed to derive additional MAs, the set of MAs of the stuck-at 0 fault on the target node u₃ are u₃=1, u₂=1, d=1, c=1, b=1, u1=1, u₄=0 and u₅=1. Second, using the same method to compute the MAs of the stuck-at 1 fault on u₃, they are u₃=0, u₂=1, d=0, c=0, b=1, u₁=0, u₄=0 and u₅=0. As mentioned above, the nodes u₁ and d have different values in the MA sets so that they are the substitute nodes of u₃. Note that although node u₅ also satisfies the requirements, it is excluded from being a substitute node of u₃. This is because that the node u₅ is in the transitive fanout cone of u₃, and replacing u₃ with u₅ will result in a cyclic combinational circuit, which is an invalid combinational circuit, as shown in FIG. 4. Thus, u₅ is not a substitute node of u₃.

Now, referring to FIG. 5A, it shows an embodiment of the present invention. When nₛ=1 and ns=0 are MAs of the stuck-at 0 and stuck-at 1 fault tests on the target node nₜ, respectively, the target nₜ can be replaced by the node nₛ, then it can be removed from the circuit. Moreover, referring to FIG. 5B it shows another embodiment of the present invention. When nₛ=0 and nₛ=1 are MAs of the stuck-at 0 and stuck-at 1 fault tests on the target node nₜ, respectively, nₜ can be replaced by nₛ together with an additional inverter (INV), and it can be removed from the circuit, subsequently.

The substitute node identification algorithm according to the present invention is shown as below:

Find_Substitute_Node(Node nₜ)
1. Compute MAs(nₜ=sa0).
2. Compute MAs(nₜ=sa1).
3. SubstituteNodes←nodes having different values in MAs(nt=sa0) and MAs(nₜ=sa1), and not in the transitive fanout cone of nₜ.

As mentioned above, only two logic implications are required to identify the substitute nodes for the target node. Therefore, the time of this calculation performed by a computer could be reduced effectively and the substitute nodes could be detected efficiently.

Furthermore, in step 207, the substitute node that is closest to primary inputs is used to replace the target node.

Finally, in step 209, the steps 203˜207 are repeated for removing the replaceable nodes and simplifying the circuit. In this step, it is combined with two techniques which are redundancy removal and MA reuse. The redundancy removal is utilized to detect and remove redundancies which are obtained by the MAs calculated from the substitute node identification algorithm mentioned above. In one embodiment of the present invention, if the assignments in MAs(nₜ=sa0) are inconsistent, the target node nₜ can be replaced with a constant value “0”; and if the assignments in MAs(nₜ=sa1) are inconsistent, the target node nₜ can be replaced with a constant value “1”. Thus, replacing the target node with a constant value also reduces the complexity of the circuit. As the detection of a target node is finished, the steps 203˜207 are repeated to find substitute, nodes for replacing another target node so that the redundancy in the circuit is removed and the complexity of the circuit is reduced.

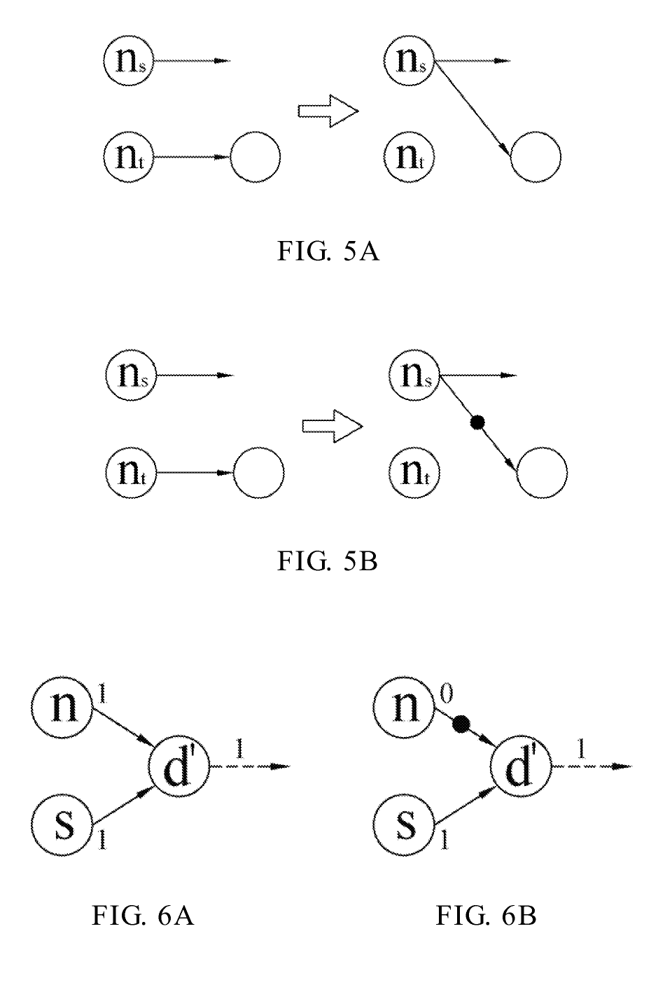

Because a VLSI circuit is a very huge and complex, the present invention also provides the technique of MA reuse to accelerate the process. Referring to FIGS. 6A-B, they illustrate the rules of MA reuse. In FIG. 6A, suppose the MAs of the stuck-at 0 fault test on the node d′ have been calculated and they are d′=1, n=1, and s=1. Consider calculating the MAs of the stuck-at 0 fault test on the node n. In this example, d′ is the only one fanout of n so that the dominators of d′ and d′ itself are the dominators of n. Thus, the MAs of the stuck-at 0 fault test on n are the same with the MAs of the stuck-at 0 fault test on d′. Similarly, in FIG. 6B, the MAs of the stuck-at 1 fault test on the node n are also the same with the MAs of the stuck-at 0 fault test on the node d′. In summary, the MAs of the stuck-at 0 fault test on the node d′ can be reused to avoid recalculating the same MA set for the stuck-at fault test on the node n when d′ is the only one fanout of n. Thus, the technique of the MA reuse could be used for accelerating the calculation process.

The algorithm for computing MAs with MA reuse is shown as below:

Calculate MAs(Node n, Logic Value v)

IF n has only one fanout d THEN

IF v = Compl(d, n) THEN

MAs(n = sav) = MAs(d = sa0);

ELSE

Compute MAs(n = sav);

ELSE

Compute MAs(n = sav).

This algorithm is utilized to check whether the node n has more than one fanout. If the node n has more than one fanout, the MAs cannot be computed by using the technique of the MA reuse. Otherwise, if the node n has only one fanout, the algorithm further checks whether v equals Comp1(d, n). Here, v is a logic value 0 or 1, and Comp1(d, n) returns 1 if there exists an INV between d and n; otherwise, Comp1(d, n) returns 0. When v equals Comp1(d, n), the technique of the MA reuse could be used. The algorithm sets the MAs of the stuck-at v fault test on the node n to the MAs of the stuck-at 0 fault test on the node d′. However, if v does not equal Comp1(d, n), the technique of the MA reuse cannot be used and the algorithm computes the MAs of the stuck-at v fault test on the node n.

Therefore, the overall algorithm for the fast detection of node mergers and simplification of a circuit according to the present invention is integrated as below:

Area_Optimization (Circuit C)

For each node n in C in the DFS order from POs to PIs
1. Calculate_MAs(n, 0).
   a. If there exists a conflict in MAs(n=sa0), replace n with 0, clean each node's MAs and continue.
   b. If n has a fanin which only has one fanout, store MAs(n=sa0).
2. Calculate_MAs(n, 1).
   a. If there exists a conflict in MAs(n=sa1), replace n with 1, clean each node's MAs and continue.
3. SubstituteNodes←nodes having the different values in MAs(n=sa0) and MAs(n=sa1), and not in the transitive fanout cone of n.
4. Replace n with a node which is in the set of SubstituteNodes and closest to PIs.
5. If n is replaced, clean each node's MAs.

This overall algorithm according to the present invention iteratively selects a node n as a target node in a depth-first search (DFS) order from POs to PIs, and the process of the overall algorithm is described as follows. For a node n, first, the MAs for the stuck-at 0 fault (sa0) on the node n are computed. If there exists a conflict among the values in the MAs, it replaces n with 0 and cleans each node's MAs, and then continues to consider the next target node. Otherwise, if there is no conflict, the MAs are stored for reusing. Second, the MAs for the stuck-at 1 (sa1) on the node n are computed. If there exists a conflict among the values in the MAs, it replaces n with 1 and cleans each node's MAs, and then continues to consider the next node. Otherwise, if there is no conflict, the nodes that have different values in the MAs for the stuck-at 0 and stuck-at 1 fault tests on n are the substitute nodes of n. Next, the substitute node that is closest to the PIs is used to replace n. Finally, if n is replaced, the algorithm cleans each node's MAs, and continues to consider the next target node for simplifying the circuit.

Sequentially, the method for fast detection of node mergers according to the present invention is used in actual implementation and described in detail as shown in Table 1. Referring to Table 1, it shows the results of applying several benchmarks to the method for fast detection of node mergers of the present invention.

The benchmarks are from the International Workshop on Logic Synthesis (IWLS) 2005 suite (http://iwls.org/iwls2005/benchmarks.html). For example, the benchmark “stepper.” which is one benchmark of the IWLS 2005 suite and has 184 nodes. The substitute nodes for 23 of its nodes, or 12.5% could be found by applying the method of the present invention. Additionally, there are 91 substitute nodes in total and this ratio with respect to the number of the target nodes having substitute nodes is 3.96. That is, there is an average of 3.96 substitute nodes for a node which has substitute nodes. Moreover, in the embodiment, the overall time for the computer to achieve the detection is only 0.01 seconds.

In order to enhance the advantage of the present invention, the comparison results of the present invention with the prior art are illustrated in Table 2. For example, the benchmark “pci_spoci.” which is one benchmark of the IWLS 2005 suite and has 878 nodes. In Table 2, it shows that the spent time for the detection of node mergers and simplification of a circuit by the method of the present invention is only 0.24 seconds, however, 6 seconds are required by the method of the prior art. Therefore, the present invention can reduce the CPU time effectively, and the result of the simplification of a circuit can approach to 10.93%. On the other hand, from the aspect of efficiency comparison, the overall CPU time is only 254.24 seconds, which is much less than 21887 seconds required by the prior art. The present invention has a speedup of 86 times.

TABLE 1

| benchmark | N | Nₜ | % | Nₛ | ratio | time (s) |
|---|---|---|---|---|---|---|
| stepper. | 184 | 23 | 12.5 | 91 | 3.96 | 0.01 |
| C432 | 209 | 72 | 34.45 | 313 | 4.35 | 0.02 |
| C880 | 327 | 6 | 1.83 | 6 | 1 | 0.01 |
| C1908 | 414 | 11 | 2.66 | 13 | 1.18 | 0.07 |
| usb_phy | 459 | 25 | 5.45 | 75 | 3 | 0.03 |
| C2670 | 717 | 28 | 3.91 | 33 | 1.18 | 0.09 |
| sasc | 784 | 10 | 1.28 | 12 | 1.2 | 0.05 |
| C3540 | 1038 | 29 | 2.79 | 33 | 1.14 | 0.27 |
| rot | 1063 | 42 | 3.95 | 59 | 1.4 | 0.15 |
| simple_spi | 1079 | 26 | 2.41 | 125 | 4.81 | 0.11 |
| i2c | 1306 | 80 | 6.13 | 174 | 2.18 | 0.21 |
| pci_spoci. | 1451 | 170 | 11.72 | 890 | 5.24 | 0.62 |
| dalu | 1740 | 217 | 12.47 | 560 | 2.58 | 0.95 |
| C5315 | 1773 | 33 | 1.86 | 113 | 3.42 | 0.16 |
| s9234 | 1958 | 175 | 8.94 | 270 | 1.54 | 0.37 |
| C7552 | 2074 | 60 | 2.89 | 104 | 1.73 | 0.41 |
| C6288 | 2337 | 2 | 0.09 | 2 | 1 | 0.45 |
| i10 | 2673 | 626 | 23.42 | 1076 | 1.72 | 1.35 |
| s13207 | 2719 | 159 | 5.85 | 231 | 1.45 | 0.64 |
| systemcdes | 3190 | 147 | 4.61 | 301 | 2.05 | 1.51 |
| i8 | 3310 | 1533 | 46.31 | 11622 | 7.58 | 3.84 |
| spi | 4053 | 65 | 1.6 | 91 | 1.4 | 3.35 |
| des_area | 4857 | 80 | 1.65 | 152 | 1.9 | 5.58 |
| alu4 | 5270 | 206 | 3.91 | 236 | 1.15 | 54.87 |
| s38417 | 9219 | 173 | 1.88 | 257 | 1.49 | 1.45 |
| tv80 | 9609 | 496 | 5.16 | 3864 | 7.79 | 17.19 |
| b20 | 12219 | 849 | 6.95 | 1640 | 1.93 | 17.28 |
| s38584 | 12400 | 549 | 4.43 | 1109 | 2.02 | 17.02 |
| b21 | 12782 | 1094 | 8.56 | 2066 | 1.89 | 19.34 |
| systemcaes | 13054 | 202 | 1.55 | 380 | 1.88 | 17.71 |
| ac97_ctrl | 14496 | 98 | 0.68 | 242 | 2.47 | 3.22 |
| mem_ctrl | 15641 | 1537 | 9.83 | 3588 | 2.33 | 98.8 |
| usb_funct | 15894 | 370 | 2.33 | 1271 | 3.44 | 6.33 |
| b22 | 18488 | 1047 | 5.66 | 2127 | 2.03 | 24.95 |
| aes_core | 21513 | 452 | 2.1 | 1742 | 3.85 | 15.17 |
| pci_bridge32 | 24369 | 309 | 1.27 | 621 | 2.01 | 21.69 |
| wb_conmax | 48429 | 5608 | 11.58 | 41996 | 7.49 | 28.18 |
| b17 | 52920 | 1565 | 2.96 | 5515 | 3.52 | 174.49 |
| des_perf | 79288 | 2505 | 3.16 | 6195 | 2.47 | 51.37 |

| | | |
|---|---|---|
| average | 6.94 | 2.69 |

| | |
|---|---|
| total | 589.31 |

TABLE 2

| | | The present invention | | Prior art | |
|---|---|---|---|---|---|
| benchmark | N | % | time (s) | % | time (s) |
| pci_spoci. | 878 | 10.93 | 0.24 | 9.2 | 6 |
| i2c | 941 | 1.91 | 0.11 | 3.2 | 3 |
| dalu | 1057 | 6.81 | 0.3 | 12 | 10 |
| C5315 | 1310 | 0.46 | 0.09 | 0.7 | 2 |
| s9234 | 1353 | 1.63 | 0.16 | 1.2 | 8 |
| C7552 | 1410 | 2.77 | 0.28 | 3.4 | 8 |
| i10 | 1852 | 5.24 | 0.64 | 1.3 | 12 |
| s13207 | 2108 | 2.13 | 0.48 | 1.8 | 17 |
| alu4 | 2471 | 21.45 | 5.29 | 22.9 | 64 |
| systemcdes | 2641 | 1.55 | 0.94 | 4.7 | 9 |
| spi | 3429 | 0.52 | 2.71 | 1.3 | 84 |
| tv80 | 7233 | 3.77 | 10.6 | 7.1 | 1445 |
| s38417 | 8185 | 0.6 | 1.15 | 1 | 275 |
| mem_ctrl | 8815 | 17.67 | 6.76 | 18 | 738 |
| s38584 | 9990 | 1.44 | 11.44 | 0.8 | 223 |
| ac97_ctrl | 10395 | 0.15 | 1.96 | 2 | 188 |
| systemcaes | 10585 | 0.6 | 13.09 | 3.8 | 360 |
| usb_funct | 13320 | 2.21 | 5.89 | 1.4 | 681 |
| pci_bridge32 | 17814 | 0.48 | 12.04 | 0.1 | 1134 |
| aes_core | 20509 | 0.67 | 13.23 | 8.6 | 1620 |
| b17 | 34523 | 1.58 | 72.4 | 1.6 | 5000 |
| wb_conmax | 41070 | 4.39 | 31.88 | 6.2 | 5000 |
| des_perf | 71327 | 1.75 | 62.56 | 3.7 | 5000 |
| average | | 3.94 | | 5.04 | |
| total | | | 254.24 | | 21887 |
| ratio | | | 1 | | 86.09 |

As mentioned-above, the method for fast detection and simplification of a circuit according to the present invention can merge nodes for simplifying a VLSI circuit effectively, and the CPU time of detecting node mergers also can be reduced successively.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalency are intended to be embraced therein.

What is claimed is:

1. A method for fast detection of substitute nodes, the steps of said method comprising:
(a) providing a circuit including a plurality of nodes;
(b) selecting a target node for computing mandatory assignments (MAs) of stuck-at 0 and stuck-at 1 fault tests on said target node, respectively, by a computer; and
(c) finding said substitute nodes by utilizing said MAs of stuck-at 0 and stuck-at 1 fault tests of said target node by said computer.

2. The method according to claim 1, wherein said plurality of nodes comprise a plurality of logic gates.

3. The method according to claim 2, wherein said plurality of logic gates comprises 2-input AND gates.

4. A method for fast detection of node mergers and simplification of a circuit, the steps of said method comprising:
(a) providing a circuit including a plurality of nodes;
(b) selecting a target node for computing mandatory assignments (MAs) of stuck-at 0 and stuck-at 1 fault tests on said target node respectively by a computer;
(c) finding said substitute nodes by utilizing said MAs of stuck-at 0 and stuck-at 1 fault tests of said target node by a computer;
(d) replacing said target node by using said substitute node closest to primary inputs; and
(e) repeating said steps (b)˜(d) for removing replaceable said nodes and simplifying said circuit.

5. The method according to claim 4, wherein said plurality of nodes comprise a plurality of logic gates.

6. The method according to claim 5, wherein said plurality of logic gates comprises 2-input AND gates.

7. The method according to claim 4, wherein said step (e) is engaged with a plurality of techniques, and said techniques include redundancy removal and mandatory assignment reuse.

8. The method according to claim 7, wherein said redundancy removal is that using “1” or “0” to replace said node for simplifying said circuit.

9. The method according to claim 7, wherein said mandatory assignment reuse defines that a particular node in said plurality of nodes has the same mandatory assignment set with a fanout of it, and thus, can reuse the mandatory assignments for accelerating the computing process.

10. The method according to claim 4, wherein said target node is selected by using depth-first search technique.

11. A method for fast detection of complemented substitute nodes, the steps of said method comprising:
(a) providing a circuit including a plurality of nodes;
(b) selecting a target node for computing mandatory assignments (MAs) of stuck-at 0 and stuck-at 1 fault tests on said target node, respectively, by a computer; and
(c) finding said substitute nodes including an inverter by utilizing different values of said MAs of stuck-at 0 and stuck-at 1 fault tests of said target node by a computer;
wherein said inverter is utilized to transfer “1” to “0” or “0” to “1”.

12. The method according to claim 11, wherein said plurality of nodes comprise a plurality of logic gates.

13. The method according to claim 12, wherein said plurality of logic gates comprises 2-input AND gates.
